(19) United States
(12) Patent Application Publication
(10) Pub. No.: US 2011/0038574 A1
(43) Pub. Date: Feb. 17, 2011

(54) AXIAL BEARING FOR A SHAFT, PARTICULARLY FOR THE SHAFT OF A WATER TURBINE

(76) Inventor: Michael Bottenschein, Neu-Ulm (DE)

Correspondence Address: FARJAMI & FARJAMI LLP, 26522 LA ALAMEDA AVENUE, SUITE 360, MISSION VIEJO, CA, 92691, US

(21) Appl. No.: 12/451,455

(22) PCT Filed: May 27, 2008
(86) PCT No.: PCT/EP2008/004189

§ 371 Date: Feb. 2, 2010

(30) Foreign Application Priority Data
Jun. 18, 2007 (DE) 10 2007 028 456.1

(51) Int. Cl. F16C 27/08; B21F 35/00

(52) U.S. Cl. 384/218; 29/896.9

(57) ABSTRACT

The invention relates to an axial bearing for absorbing high axial loads of a shaft, comprising
a bearing ring which comprises a central bore for leading through the shaft and which rests on a fixed base;
a plurality of spring elements which are made of an elastic material and are applied to the bearing ring;
a load transfer device for transferring the load from the shaft to the spring elements.

The invention is characterized by the following features:
the spring elements are elastic bodies which can be joined onto each other and/or into each other in an interlocking way in the manner of a puzzle;
the contours of the spring elements are arranged in such a way that at least from a certain loading state no gap remains between mutually adjacent spring elements.

The invention relates to an axial bearing for absorbing high axial loads.

Such bearings are used for example for water turbines or pumps with vertical shafts.

Such an axial bearing is described for example in DE 26 26 609 C3.

The bearing comprises the shaft, the shaft collar, the packing and the tracking ring as the rotating parts in the axial direction of the power flow, and the bearing blocks, the spring elements, the bearing ring and the support construction as the supporting standing parts. In order to ensure that a hydrodynamic lubricating film can be formed between the tracking ring and the bearing blocks during operation, the supporting spring elements must enable the tilting of the bearing blocks and compensate tolerances in production and mounting by axial resilience. In order to ensure sufficient resilience in known axial bearings, the parallel arrangement of individual smaller spring elements made of rubber has proven to be useful.

The spring elements consist in the known axial bearing of a rubber stamp which has a height of a few millimeters and which is vulcanized onto a thin support sheet. The vulcanization increases axial stiffness considerably. Moreover, it supports dimensional stability and minimizes the usual creeping of the rubber under load. There must be sufficient space between the adjacently arranged rubber elements. The rubber would be incompressible in the case of complete encapsulation and would not be useful for holding the bearing blocks.

The known bearing has proven its worth under moderate axial loads. In the case of very high axial loads however the transversal expansion can make the rubber elements so large that cracks will form or the vulcanization of the rubber stamp to the support sheet will be damaged. The rubber elements lose a considerable amount of stiffness and are unable to fulfill their function any longer.

The spring elements consist in the known axial bearing of small disks. They can be round or angular. There is a distance between mutually adjacent disks in the loaded and non-loaded state of the axial bearing.

The known bearing has proven its worth under moderate axial loads. From a certain magnitude of the axial load however destructions of the disk-like spring elements have been noticed. The disks are compressed very strongly. They can lose their elasticity, so that they are permanently destroyed. A destruction of the vulcanization can also occur which is disposed between the disk-like spring elements and the bearing ring.

The invention is based on the object of providing an axial bearing according to the preamble of claim 1 in such a way that it can absorb higher axial loads without destructions occurring in individual elements of the bearing, especially in the spring elements.

This object is achieved by the features of claim 1. Accordingly, the spring elements are arranged in such a way that adjacent spring elements will touch one another in the loaded state and will support each other.

The support plate and the rubber stamp vulcanized on the same have the same basic shape in the lop view. The overdimension of the larger support sheet is arranged in such a way that when placing the spring elements next to one another in an abutting relationship with support sheet next to support sheet, the rubber stamp is provided with, a sufficient defined volume for transversal expansion. When the operating loads are considerably exceeded, the rubber elements will support each other in the transversal direction. Impermissibly high deformations which lead to damage to the rubber are thus avoided.

A gap may thus remain in the unloaded state between mutually adjacent spring elements. It will become zero from a certain axial load however. The mutually adjacent spring elements thus come into mutual contact. They thus support each other. As a result, a type of constructional overload protection against destruction of the spring elements is created.

The spring elements can principally have any shape. Hexagons or rectangles or triangles as well as shapes which allow the uninterrupted joining of mutually adjacent spring elements are especially advantageous. It is also possible to provide the spring elements with any other desired shape. The important aspect is that they rest against one another without any gaps at least from a specific loading state.

Such shapes are advantageous which allow a gap-free joining of adjacent spring elements. The available support surface on the back side of the bearing block can be used effectively and the ultimate load can be increased. The hexagonal basic shape offers special advantages. When arranged edge by edge, which means in a honeycomb form, there are no continuous lines which would enable the slippage of entire rows of springs. This would be the case in triangular or rectangular elements. The obtuse inside angle of 120° does not lead to any relevant excessive tension increases in the case of strong transversal expansion in comparison with a circular spring element. The hexagonal initial shape which is non-deformed without load and the similarly hexagonal end shape under maximum load guarantee a homogeneous loading of the rubber along the circumference. If round rubber stamps were deformed up to block, irrespective of whether they are arranged in a square or hexagonal raster, there would be places on the circumference which would be supported earlier in the transversal direction and some which would be supported later. The loading along the circumference would not be homogeneous, especially under the highest load.

In the mounted state, which means when applied to the bearing ring, the entirety of all spring elements looks like a so-called puzzle which has become known as a game of patience.

Simple production is also achieved by the configuration of the spring elements in accordance with the invention: The spring elements can be punched out of a rubber plate or a plate of otherwise elastic material, e.g. by means of a so-called steel strip.

The invention is now explained in closer detail by reference to the drawings, which show in detail:

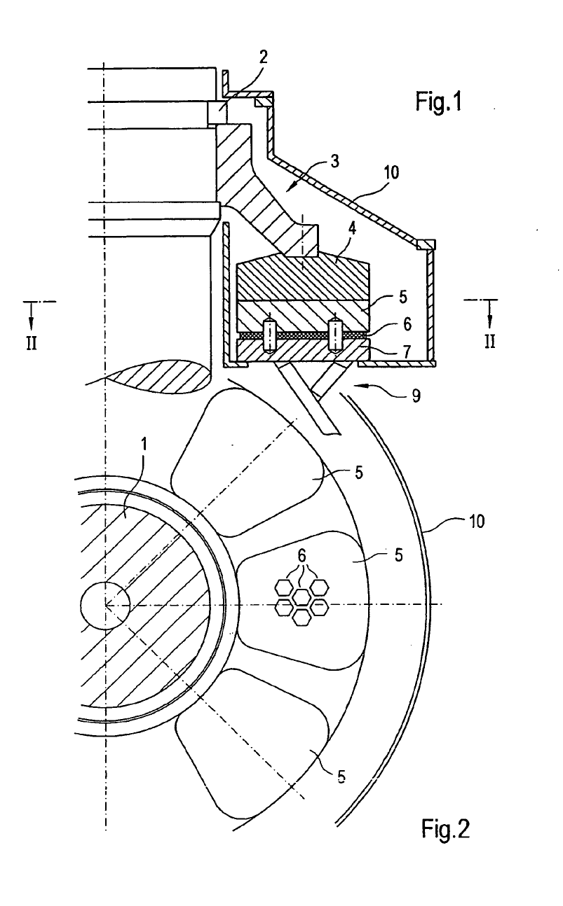

FIG. 1 shows a longitudinal section view through the axial bearing of a water turbine;

FIG. 2 shows a sectional view along the line of intersection II-II in FIG. 1;

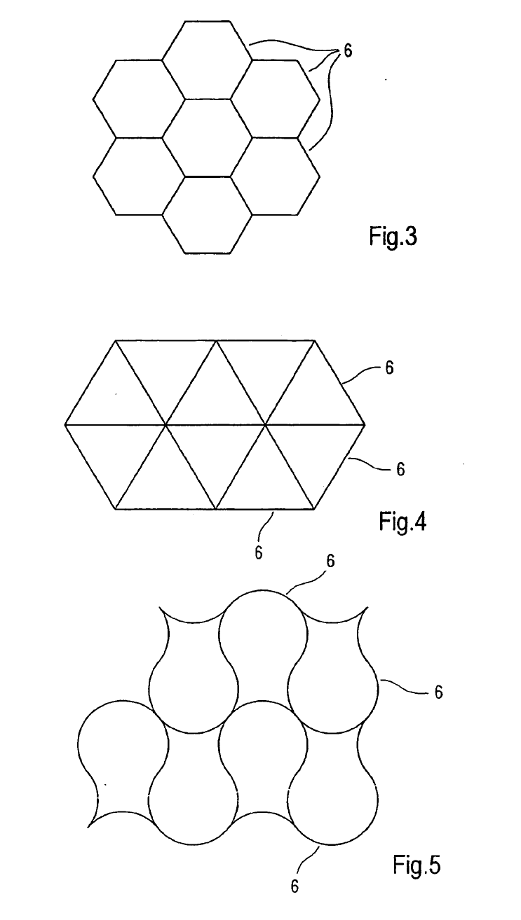

FIG. 3 shows an enlarged illustration of a top view of a plurality of hexagonal spring elements;

FIG. 4 shows an enlarged illustration of a top view of a plurality of triangular spring elements;

FIG. 5 shows an enlarged illustration of a top view of a plurality of spring elements of a non-regular shape;

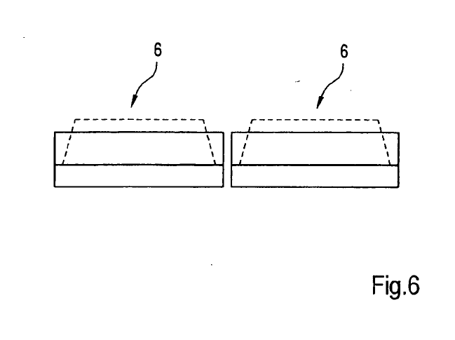

FIG. 6 shows an enlarged illustration of two mutually adjacent spring elements in the loaded and unloaded state;

FIG. 1 shows a shaft 1 with a vertical axis 1.1. The shaft is enclosed by a shaft collar 2. The shaft collar 2 is carried by a packing 3 which encloses the shaft 1. The bottom end of the packing 3 is supported on a tracking ring 4 which also encloses the shaft 1. The tracking ring 4 rests on its part on a plurality of bearing blocks 5 which are arranged evenly spaced about the shaft 1.

This is followed by the spring elements 6. They are placed on a bearing ring 7. Pins 8 engage in bore holes of the bearing blocks 5 and the bearing ring 7. A support construction 9 supports the bearing ring 7. A housing 10 encloses the shaft collar 2, packing 3, tracking ring 4, bearing blocks 5, spring elements 6 and the tracking ring 7.

The shape of the spring elements is indicated in FIG. 2. It is shown that these concern hexagonal disks.

The spring elements need not necessarily have the shape of disks. They can have another shape. When seen in a top view, they are arranged as defined in claim 1.

FIGS. 3, 4 and 5 each show a top view of different configurations of the spring elements. The spring elements 6 are hexagonal according to FIG. 3.

The spring elements 6 in accordance with FIG. 4 have the shape of equilateral triangles.

The spring elements of FIG. 5 deviate from the geometric contours. They have the shape of stamp handles.

Any other configurations are also possible. The relevant aspect is in each case that the individual spring elements are separated from one another by a separating line and that there is a mutual touching of mutually adjacent spring elements at the latest from a specific load. Such touching could also be present even before the application of an axial load.

The schematic illustration according to FIG. 6 shows the behavior of mutually adjacent spring elements in the unloaded and loaded state. The unloaded state is shown with the broken line and the loaded state on the other hand with the unbroken line.

It is shown that the individual spring element obviously has a larger thickness in the unloaded state than in the loaded state. It also has the shape of a truncated cone (see in the inclined circumferential surfaces). The circumferential surfaces do not touch one another. Rather, there is a gap between mutually adjacent circumferential surfaces.

In the loaded state the individual spring elements are obviously compressed and thus less high. The spring elements 6, 6 have a substantially rectangular cross-sectional shape. The circumferential surfaces have approached one another. They will touch each other under even stronger load.

Even when shown here, it can be appropriate or necessary to enclose the entirety of all spring elements which are associated with a bearing block 5 by a hoop. The outer spring elements can rest on such a hoop under load. The hoop can be made of sheet metal. Such a circumferential hoop prevents the slipping of the spring elements which is caused by vibrations for example and during installation and dismounting.

The advantages of the invention will be explained below as follows again:

The spring characteristic of a spring element progresses nearly linear at first under load. It increases exponentially under an even larger load however.

The possibility of an expansion of the individual spring element in one direction perpendicular to the load action, which means generally perpendicular to the longitudinal axis 1.1 of shaft 1, is limited by the invention. The available space can be utilized even more effectively by the contour of the spring elements in accordance with the invention. Any impermissibly high spring deflection is prevented by the mutual support of the spring elements.

The invention offers another further advantage concerning the production of the spring elements. The spring elements can be punched out from a slab of rubber-elastic or other material, with no, or virtually no, waste material being produced.

The spring elements 6 can be placed or vulcanized on the bearing block.

### LIST OF REFERENCE NUMERALS

1 Shaft
1.1 Axle
2 Shaft collar
3 Packing
4 Tracking ring
5 Bearing block
6 Spring elements
7 Bearing ring
8 Pin
9 Support construction
10 Housing

1-5. (canceled)

6. An axial bearing for absorbing high axial loads of a shaft, comprising
a bearing ring which comprises a central bore for leading through the shaft and which rests on a fixed base;
a plurality of spring elements which are made of an elastic material and are applied to the bearing ring;
a load transfer device for transferring the load from the shaft to the spring elements, wherein:
the spring elements are elastic bodies which can be joined onto each other and/or into each other interlocking way in the manner of a puzzle;
the contours of the spring elements are arranged in such a way that at least from a certain loading state no gap remains between it adjacent spring elements.

7. The axial hearing according to claim 6, wherein the spring elements are arranged parallel with respect to one another.

8. The axial bearing according to claim 7, wherein the spring elements have a hexagonal, rectangular or triangular shape in the direction of the load action.

9. The axial bearing according to claim 6, wherein the spring elements have a hexagonal, rectangular or triangular shape in the direction of the load action.

10. The axial bearing according to claim 6, wherein the spring elements are arranged in groups and are each covered by a hearing block.

11. The axial bearing according to claim 7, wherein the spring elements are arranged in groups and are each covered by a bearing block.

12. The axial bearing according to claim 8, wherein the spring elements are arranged in groups and are each covered by it bearing block.

13. The axial bearing according, to claim 9, wherein the spring elements are arranged in groups and are each covered by a bearing block.

14. The axial bearing according to claim 9, wherein the load transfer device comprises a packing which on the one hand supports a shaft collar which encloses the shaft and is rigidly connected with the same, and which rests on its part on a tracking ring which is arranged concentrically in relation to the shaft and rests on its part on the bearing blocks.

15. The axial bearing according to claim 10, wherein the load transfer device comprises a packing which on the one band supports a shaft collar which encloses the shaft and is rigidly connected with the same, and which rests on its part on a tracking ring which is arranged concentrically in relation to the shaft and rests on its part on the bearing blocks.

16. The axial bearing according to claim 11, wherein the load transfer device comprises a packing which on the one hand supports a shaft collar which encloses the shaft and is rigidly connected with the same, and which rests on its part on a tracking ring which is arranged concentrically in relation to the shaft and rests on its part on the bearing blocks.

17. The axial bearing according to claim 12, wherein the load transfer device comprises a packing which on the one hand supports a shaft collar which encloses the shaft and is rigidly connected with the same, and which rests on its part on a tracking ring which is arranged concentrically in relation to the shaft and rests on its part on the bearing blocks.

18. The axial hearing according to claim 13, wherein the load transfer device comprises a packing which on the one hand supports a shaft collar which encloses the shaft and is rigidly connected with the same, and which rests on its part on a tracking ring which is arranged concentrically in relation to the shaft and rests on its part on the bearing blocks.

19. A method for producing spring elements for application in the axial bearing according to claim 1, wherein the spring elements are punched out of a slab made of elastic material.

20. The method according to claim 19, wherein the spring elements are arranged parallel with respect to one another.

21. The method according to claim 19, wherein the spring elements have a hexagonal, rectangular or triangular shape in the direction of the load action.

22. The method according to claim 21, wherein the load transfer device comprises a packing which on the one hand supports a shaft collar which encloses the shaft and is rigidly connected with the same, and which rests on its part on a tracking ring which is arranged concentrically in relation to the shaft and rests on its part on the hearing blocks.

23. The method according to claim 19, wherein the spring elements are arranged in groups and are each covered by a bearing block.
